(19) United States
(12) Patent Application Publication
(10) Pub. No.: US 2005/0016310 A1
(43) Pub. Date: Jan. 27, 2005

(54) Joystick

(76) Inventor: Jorg Henle, Deubach (DE)

Correspondence Address: BACHMAN & LAPOINTE, P.C., 900 CHAPEL STREET, SUITE 1201, NEW HAVEN, CT, 06510, US

(21) Appl. No.: 10/488,571

(22) PCT Filed: Jul. 3, 2002
(86) PCT No.: PCT/EP02/07316

(30) Foreign Application Priority Data
Sep. 7, 2001 (DE) 101 44 146.0

(51) Int. Cl. G05G 1/00

(52) U.S. Cl. 74/469

(57) ABSTRACT

A control stick having a linear and rotational axis of the movement for controlling all types of vehicles, especially airplanes and simulators, comprising a control stick that can be moved linearly and rotationally relative to a base plate. A control element that can be moved linearly relative to the base plate and is connected to the control stick on one end.

### BACKGROUND OF THE INVENTION

The present invention relates to a control stick having a linear and rotational movement axis for controlling vehicles of all types, in particular aircraft or simulators, having a control rod which can be moved linearly and rotationally with respect to a base plate.

Such control sticks are commercially known and available in a variety of shapes and embodiments. They are used to control different vehicles, in particular for controlling vehicles, but also for controlling simulators, in particular flight simulators.

The disadvantage with the conventional control sticks is that they are subject to a certain degree of wear, are difficult to activate and are costly to manufacture.

GB 2 148 460 A discloses a monitoring device for side sticks. In this monitoring device, a swiveling movement of a side stick is converted into a rotational movement starting from a shaft via a pitch circle and transmitted onto a second shaft which is arranged in parallel therewith and which is adjoined by position sensors which pick up the position of the control stick or side stick.

U.S. Pat. No. 3,209,612 describes a monitoring device for activating the elevator, a linear movement being converted into a rotational movement by means of a pitch circle.

The present invention is therefore based on the object of providing a control stick of the type mentioned at the beginning which eliminates the aforesaid disadvantages and with which vehicles, in particular aircraft or a control simulation, can be controlled in a very precise way. In addition, the weight, the installation space and the manufacturing costs are to be reduced and the precision of the control is to be improved.

### SUMMARY OF THE INVENTION

The foregoing object is achieved by the present invention wherein a control element (7) which can be moved linearly with respect to the base plate (3) adjoins a control rod (1) at one end, and the control rod (1) which lies on a common axis (M) is connected to a drive element (12.2), in particular an electric motor and/or gear element (13.2), which lies on the axis (M).

In the present invention, a control element can be moved linearly with respect to the base plate or at least one guide element. The control rod engages in the control element and is in engagement with a gear element and/or drive element, and the drive element and/or gear element can directly receive the rotational movement at one end, or be driven or controlled actively by the drive element, for example for autopilot operation or simulation operation or gear mechanisms.

As a result, the position of the actual operating state of the vehicle, in particular of the aircraft, can be recognized precisely by the pilot.

In addition, an advantage with the present invention is that the control element can be moved to and fro linearly between a securing element and the base plate by means of the guide elements. Corresponding dimensionally highly precise guides ensure that precise linear guidance of the control element or of the control rod continues to be ensured, the drive element and/or gear element which are connected to the control rod being also moved linearly at the same time.

A spindle element is preferably rotatably mounted between the base plate and the securing element and said spindle element rotationally drives, by means of a drive sleeve assigned to the control element, during the linear movement of the spindle element. As a result, a linear movement of the control element is converted or transmitted into a rotational movement of the spindle element.

At one end of the spindle element, preferably in the region of the securing element, it is adjoined by at least one drive element and/or gear element or is in engagement with them. As a result, depending on the number of revolutions it is possible to determine precisely the linear position in which the control stick or the control rod is located.

By means of an active actuation of the gear element and/or drive element it is then possible to drive the spindle element, and correspondingly the control rod or its gripping element can be moved to and fro linearly. By means of the coupling of the two drive elements in a linear and rotational fashion, it is possible for the control stick to be controlled in a linearly and/or rotationally active fashion, but also passively. This is of particular significance in the present invention. As a result, the control stick can be used very universally.

A further advantage is that this control stick operates with very low friction and virtually free of play with a linear and rotational movement axis since drive elements, particularly electric motors which operate virtually without offset, are also used. A displacement measuring system is preferably seated on each drive element in order to precisely receive a rotational movement of the drive element, of the control rod and/or of the spindle element, and process it further as a signal.

It has also proven advantageous to assign the control element and/or the gripping element at least one force sensor and/or torque sensor in order to determine the manual forces or actively generate by means of the drive elements counterforces that can be determined correspondingly during the simulation or rotational and linear countermovements.

### BRIEF DESCRIPTION OF THE DRAWINGS

Further advantages, features and details of the invention emerge from the subsequent description of the preferred exemplary embodiments and with reference to the drawing, in which:

FIG. 1 shows a schematically illustrated plan view of a control stick according to the invention with a linear and a rotational movement axis;

FIG. 2 shows a schematically illustrated side view of the control stick according to FIG. 1 in a position of rest;

FIG. 3 shows a schematically illustrated plan view of the control stick according to FIGS. 1 and 2 in a possible position of use.

### DETAILED DESCRIPTION

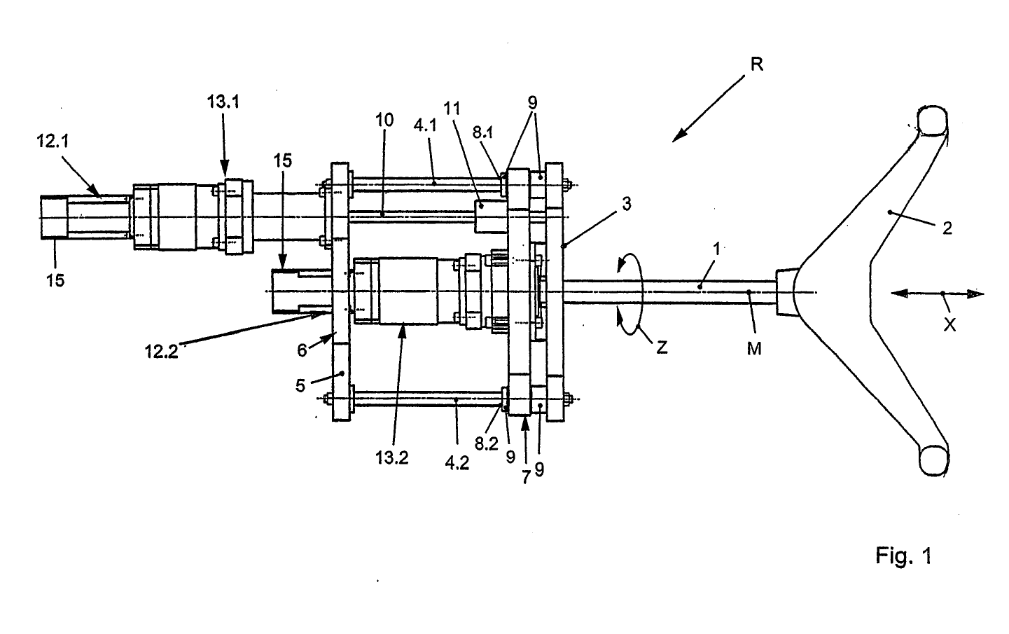

According to FIG. 1, an inventive control stick R has a control rod 1 for controlling vehicles of all types, in particular for controlling aircraft or simulators, said control rod 1 being adjoined at one end by a gripping element 2, a control stick or the like. The gripping element 2 is operated by the fingers of the human hand and can move the control rod 1 to and fro linearly along a central axis M in the direction of the double arrow illustrated as a movement axis X. Here, the control rod 1 engages through a base plate 3.

Lateral guide elements 4.1, 4.2 adjoin the base plate 3 and hold at one end a securing element 5 as a securing plate. The securing element 5 is provided in the center with an opening 6.

It is important in the present invention that a control element 7 is provided between the base plate 3 and the securing element 5, which control element 7 is provided with corresponding, matching guides 8.1, 8.2 through which the guide elements 4.1, 4.2 engage. The guides 8.1, 8.2 are configured or determined in a dimensionally precise fashion with respect to the guide elements 4.1, 4.2. As a result, the control element 7 can be moved linearly to and fro between the base plate 3 and securing element 5 in the direction of movement illustrated.

The control element 7 can be provided at both ends, preferably in the region of the guides 8.1, 8.2, with at least one spacer element 9 which serves on the one hand as a stop or on the other hand, if it is constructed from elastic material, as a damping element, or can be provided for damping the stop. However, the spacer element 9 can also be a component of the base plate 3 or securing element 5.

It is also important in the present invention that a spindle element 10 is preferably rotatably mounted between the base plate 3 and securing element 5 and is arranged offset in parallel with the central axis M, which spindle element 10 is rotatably driven by means of a corresponding sleeve 11—permanently assigned to the control element 7—when the sleeve 11 moves linearly in the illustrated direction X of movement. As a result, a linear movement of the control element 7 is converted into a rotational movement of the spindle element 10. At one end of the spindle element 10, in particular in the region of the securing element 5, a drive element and/or gear element 12.1/13.1 is connected in a releasable fashion to the securing element 5 and is in engagement with the spindle element 10.

In addition, it is important in the present invention that a further drive element and/or gear element 12.2/13.2 are/is also assigned to the control element 7, said drive element and/or gear element 12.2/13.2 being in engagement with the control rod 1, in particular being connected to it.

The latter can receive a rotational movement about the central axis M in the illustrated direction Z of movement and/or further process it and/or move/control it actively.

It is also important that, by means of the opening 6 in the securing element 5, the drive element and/or gear element 12.2/13.3 which are connected to the control element 7 can be moved through the opening 6 of the securing element 5 during the linear movement of the control rod 1.

As a result of the parallel offset between the central axis M and the spindle element 10 or as a result of the parallel offset of the drive elements and/or gear elements 12.1/13.1 with respect to the drive elements or gear elements 12.2/13.2, the drive element 12.2 and/or gear element 13.2 can be moved linearly to and fro past the spindle element 10 with the adjoining drive element and/or gear element 12.1, 13.1 linearly in the direction X of movement.

It is also important that the control element 7 permits a liner movement only through the guides 8.1, 8.2 and the guide elements 4.1, 4.2, only a rotational movement of the control rod 1 about the direction Z of movement being transmitted to the drive element and/or gear element 12.2/13.2, or an active rotational controllable movement of the drive element and/or gear element 12.2/13.3 being capable of being transmitted to the control rod.

A further particular feature of the present invention is also that the control element 7 can be moved linearly through the linear movement of the control rod 1, and, as a result, the spindle element 10 can be driven rotationally. This in turn transmits the rotational movement to the drive element 12.1 and/or gear element 13.1.

As a result, on the one hand, it is possible to carry out control precisely and determine the parameters of the control precisely.

In addition, a linear, controlled movement of the control rod 1 or of the gripping element 2 can be carried out by means of, for example, active activation of the drive element.

In addition, it is advantageous in the present invention that, for example, in autopilot control or in simulator operation, the drive element 12.1 and/or the gear element 13.1 can be driven actively and they then drive the spindles 10 rotationally in order to move the control element 7, and thus the control rod 1 and the gripping element 2, to and fro linearly. In this way, the pilot immediately recognizes the operating state in which his vehicle, in particular his aircraft, is in.

The rotational movement of the gripping element 2 about the direction of movement Z, i.e. about the central axis M, can also be driven actively and/or passively in the way described above, in that the drive element 12.2 and/or gear element 13.2 can also be moved at the same time passively by the rotational movement of the control rod 1, or can be driven actively by the gear element 13.2 and/or drive element 12.2.

The drive elements 12.1, 12.2 are preferably each adjoined by at least one displacement measuring system 15 which converts the rotational movement of the spindle element 10 and/or the rotational movement of the control rod 1 into processable signals. These can be used on the one hand for the passive control of a computer, for example as a safety signal for additionally monitoring the operating state.

In addition, these signals can be used to control corresponding adjoining elements, motors, control units, drive units, etc. by means of manual activation of the control rod 1 or of the base plate 3 in the event of a power failure, for example.

It is advantageous here that as a result of a high pitch of the spindle element it is not of self-locking design and the base plate 3 and the control rod 1 can be moved to and fro in the direction X of movement at any time, even in the event of a power failure. As a result of the fact that no self-locking of the spindle element 10 takes place, the control stick R is very operationally reliable, even, for example, in the event of a power failure, so that the corresponding signals can then always also be generated or possibly further processed by means of the displacement measurement systems 15 which are seated on the drive elements 12.1, 12.2. This contributes considerably to the safety of such a control stick.

It has also proven particularly advantageous here to use, as drive elements 12.1/12.2, electric motors which operate virtually without offset and with low friction.

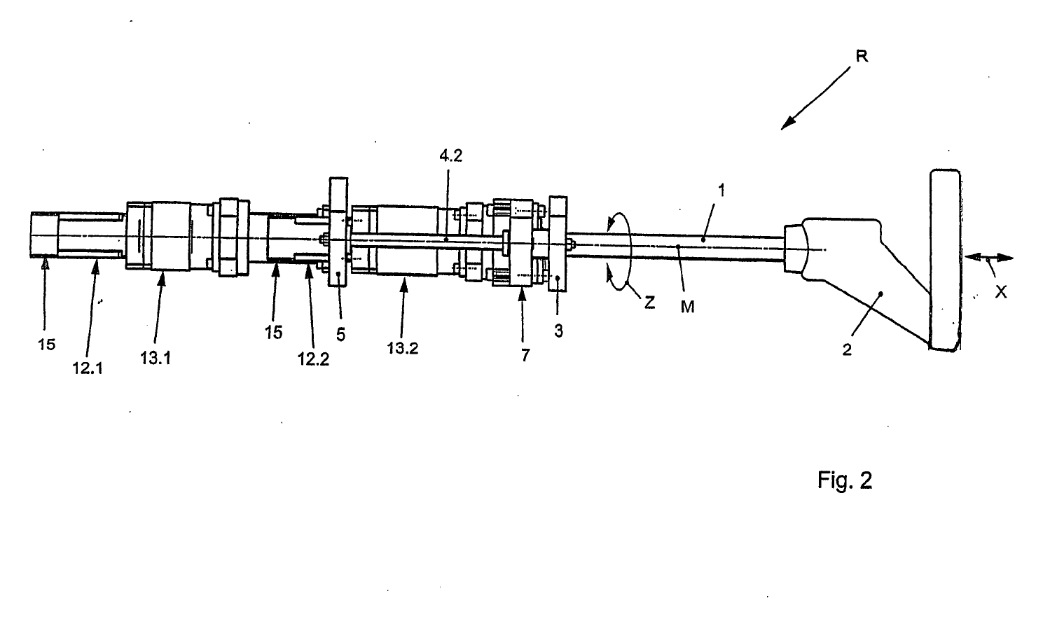

FIG. 2 shows that the control stick R can be of very flat, small and compact design, as a result of which its installation weight, in particular its installation size, can be considerably reduced. This is also due, under certain circumstances, to the parallel arrangement of the drive element and/or gear element 12.2/13.2 with respect to the spindle element 10.

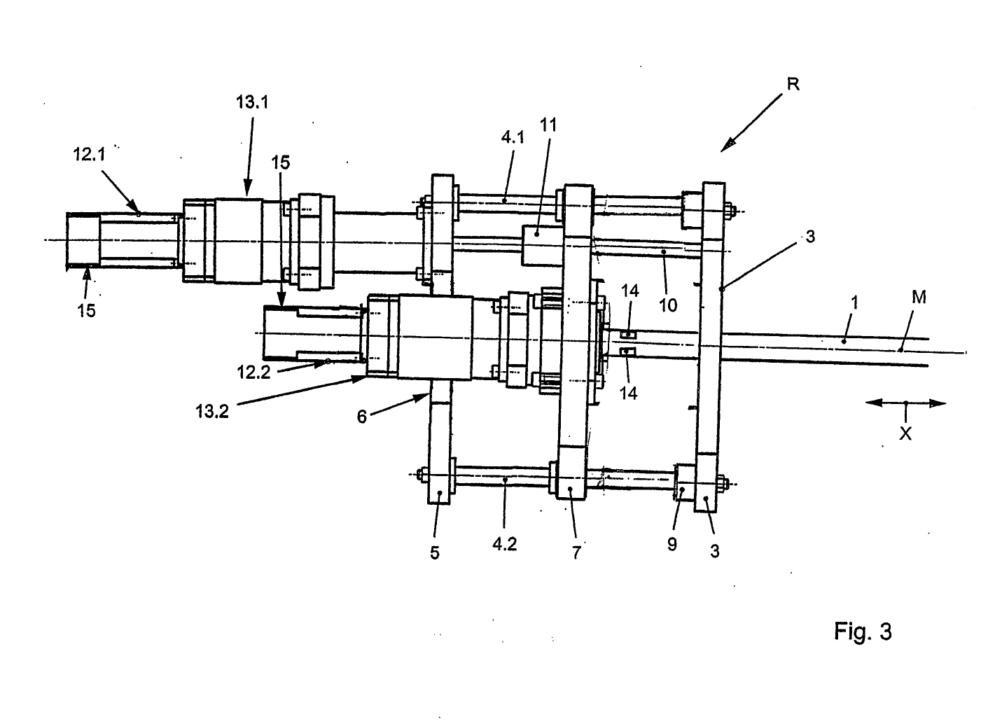

In the exemplary embodiment according to FIG. 3, a possible position of use is shown as a plan view of the control stick R, in which position of use it is apparent that the control element 7 can be moved linearly with respect to the securing element 5. Here, the drive element 12.2 and/or gear element 13.2 engage/engages through the opening 6 of the securing element 5.

It has also proven advantageous to assign the control rod 1 at least one force sensor and/or torque sensor 14 in order to precisely determine and measure the external force or the external torque which is applied to the control rod 1 via the gripping element 2. As a result, the control rod 1 can then be influenced by means of the active actuation of the drive elements and/or gear elements 12.1, 12.2 and, respectively, 13/1, 13.2.

1. A control stick having a linear and rotational movement axis comprising a control rod (1) movable linearly and rotationally with respect to a base plate (3), and a control element (7) movable linearly with respect to the base plate (3) adjoins the control rod (1) at one end.

2. The control stick as claimed in claim 1, wherein at least one guide element (4) for linearly guiding the control element (7) adjoins the base plate (3), and a securing element (5) is provided at one end of the guide element (4).

3. The control stick as claimed in claim 2, wherein the control element (7) is guided so as to be linearly movable along the at least one guide element (4.1, 4.2) between the base plate (3) and securing element (5).

4. The control stick as claimed in at least one of claims 1 to 3, wherein the control element (7) is in engagement with at least one spindle element (10), and the control element (7) intermeshes with the at least one spindle element (10) during the linear movement.

5. The control stick as claimed in claim 4, wherein the at least one spindle element (10) is rotatably mounted in at least one of the base plate (4) and the securing element (5).

6. The control stick as claimed in claim 4, wherein the spindle element (10) is connected to a drive means (12.1), (13.1).

7. The control stick as claimed in claim 6, wherein the drive means (12.1), (13.1) is fixed in a releasable fashion to the securing element (5) and is in engagement with the spindle element (10).

8. The control stick as claimed in claim 4, including drive means (12.1, 13.1) for transmitting a linear movement of the control element (7) in a rotational fashion to the at least one spindle element (10), for the rotational movement of the spindle element (10).

9. The control stick as claimed in claim 6, wherein the control rod (1) is connected to a further drive means (12.2, 13.2) in a releasable fashion to the control element (7).

10. The control stick as claimed in claim 9, wherein a rotational movement of the control rod (1) can be transmitted to the further drive means, or an actuable, controllable active rotational movement of the further drive means (12.2, 13.2) can be transmitted to the control rod (1).

11. The control stick as claimed in claim 9, wherein the further drive means (12.2, 13.2) is connected to the control element (7), and are linearly movable with respect to the securing element (5) through an opening (6) in the securing element (5).

12. The control stick as claimed in claim 1, wherein the control rod (1) is assigned at least one force sensor and/or torque sensor (14).

13. The control stick as claimed in claim 9, wherein both drive means can be driven actively and/or can be operated passively, so as to determine the position of the control rod (1).

14. The control stick as claimed in claim 13, wherein both drive means are assigned at least one displacement measuring system (15) which converts a mechanical movement into signals which can be evaluated.

15. The control stick as claimed in claim 6, wherein the spindle element (10) can be moved manually over the base plate (3), and can be driven in a non-self-locking fashion and free of play by means of the base plate (3).
